(19) United States
(12) Patent Application Publication
(10) Pub. No.: US 2018/0000574 A1
(43) Pub. Date: Jan. 4, 2018

(54) Dental Appliances

(71) Applicant: Americo Fernandes, Winnipeg (CA)

(72) Inventor: Americo Fernandes, Winnipeg (CA)

(21) Appl. No.: 15/545,315

(22) PCT Filed: Jan. 20, 2016
(86) PCT No.: PCT/IB2016/000100

§ 371 Date: Jul. 20, 2017

Related U.S. Application Data
(60) Provisional application No. 62/106,515, filed on Jan. 22, 2015.

(51) Int. Cl. A61C 19/06; A61C 13/00; A61C 9/00

(52) U.S. Cl. CPC A61C 19/063; A61C 13/0004; A61C 9/004

(57) ABSTRACT

The present invention provides methods and apparatuses suitable or treating conditions such as dry mouth. An example embodiment of the present invention provides a method of treating dry mouth condition in a patient, comprising: (a) producing an appliance that is custom fit to the patient's teeth, with additional spaces configured to retain and deliver a therapeutic agent effective in treating dry mouth condition to teeth where treatment is desired; (b) applying the agent to the appliance such that the therapeutic agent is retained in at least some of the additional spaces; and (c) mounting the appliance with the patient's teeth such that the appliance delivers the therapeutic agent to the teeth where treatment is desired.

### TECHNICAL FIELD

The present invention is related to the field of treatment of conditions such as dry mouth, using a dental appliance produced specifically for an individual patient.

### BACKGROUND

Dental appliances are known for progressive correction of orthodontic conditions, e.g., the InvisAlign (trademark of its owner) system. Dental appliances are also known for protection of teeth against damage from grinding during sleep. Such appliances are generally in the form of a tray or similarly shaped piece of acrylic or similar material, and custom fit to tightly conform to the individual patient's teeth. Such custom appliances are costly and time-consuming to prepare, and can involve multiple trips to the dentist's office, physical negative impressions, and custom laboratory production. They are also limited to a single function, e.g., orthodontic treatment or protecting against grinding.

### DESCRIPTION OF INVENTION

The present invention(s) comprise several improvements related to design, production, and application of dental appliances. Each aspect can comprise its own invention. Further, the various aspects can be used in combination with conventional practice, or with the other invention(s), to yield additional integrated invention(s).

An example embodiment of the present invention provides a method of treating dry mouth condition in a patient, comprising: (a) producing an appliance that is custom fit to the patient's teeth, with additional spaces configured to retain and deliver a therapeutic agent effective in treating dry mouth condition to teeth where treatment is desired; (b) applying the agent to the appliance such that the therapeutic agent is retained in at least some of the additional spaces; and (c) mounting the appliance with the patient's teeth such that the appliance delivers the therapeutic agent to the teeth where treatment is desired.

In some example embodiments, the appliance can be produced by obtaining a digital representation of the patient's mouth, producing a three dimensional model of the patient's mouth from the digital representation, producing a three dimensional model of an appliance from the three dimensional model of the patient's mouth adjusted to provide space for a therapeutic agent to be disposed in the appliance and dispensed to the patient, and producing an appliance from the three dimensional model of the appliance.

In some example embodiments, the space for a therapeutic agent comprises open volumes adjacent one or more teeth, wherein each open volume is configured to accept a volume of therapeutic agent intended for the corresponding tooth.

In some example embodiments, at least some of the open volumes are configured to accept different volumes of therapeutic agent.

In some example embodiments, at least a portion of the surface of the appliance that will be disposed adjacent the patient's mouth has a porosity, permeability, or both configured to dispense a therapeutic agent at a desired release rate.

An example embodiment of the present invention provides a method of producing an appliance suitable for use with a therapeutic agent in treating conditions such as dry mouth, comprising obtaining a digital representation of the patient's mouth, producing a three dimensional model of the patient's mouth from the digital representation, producing a three dimensional model of an appliance from the three dimensional model of the patient's mouth adjusted to provide space for a therapeutic agent to be disposed in the appliance and dispensed to the patient, and producing an appliance from the three dimensional model of the appliance.

Some example embodiments provide an appliance, produced by any of the methods described or claimed herein.

In some example embodiments, the therapeutic agent comprises a combination of glycerine, xylitol, and NaCl. In some example embodiments, the therapeutic agent comprises a viscosity controlling agent, an anti-cariogenic agent, an anti-inflammatory agent, and an antiseptic agent.

### BRIEF DESCRIPTION OF THE DRAWINGS

FIG. 1 is a schematic illustration of obtaining a physical impression of a patient's teeth.

FIG. 2 is a schematic illustration of conversion of a physical impression to a digital 3D model.

FIG. 3 is a schematic illustration of a custom dental tray.

FIG. 4 is a schematic illustration of a custom dental tray.

FIG. 5 is a schematic illustration of a custom dental tray.

### MODES FOR CARRYING OUT THE INVENTION AND INDUSTRIAL APPLICABILITY

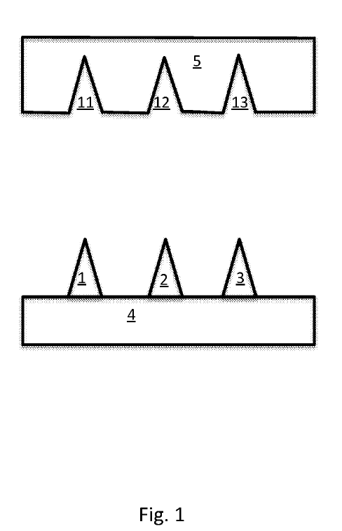

In one example method, a rubber-like physical impression of a patient's teeth is obtained, for example using conventional methods as illustrated in FIG. 1, wherein is represented the patient's jaw or gum 4, and three individual teeth 1, 2, 3. A rubber-like impression 5 can be obtained by conventional methods, with gaps 11, 12, 13 in the impression corresponding to the shape and location of the teeth.

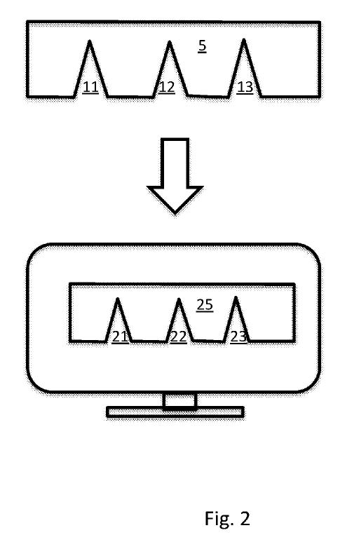

A 3D digital model of the patient's teeth can then be obtained. This can be by direct scanning of the mouth (instead of the physical impression described previously). Alternately, the physical impression can be converted to a digital 3D model by X-ray or other imaging techniques, as illustrated in FIG. 2. X-ray and other penetrative techniques can allow greater precision and fewer problems from hidden features than can be obtained with some optical scanning technologies. The digital model comprises an overall model 25 reflecting open volumes 21, 22, 23 corresponding to individual teeth as in the impression.

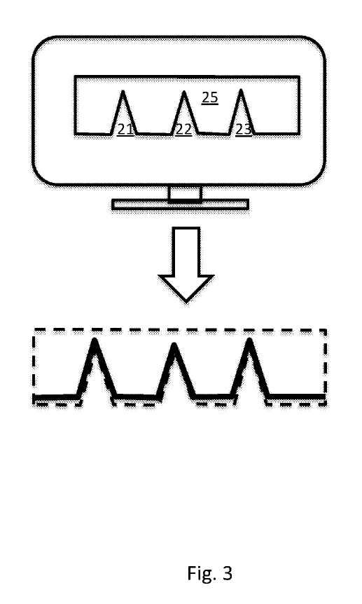

A custom dental tray can be fabricated based on the digital 3D model, as illustrated in FIG. 3. In the figure, the dashed line represents the 3D digital model, and the heavy line represents the surface of the custom dental tray (also called a dental appliance, or an appliance). The custom dental tray can be produced in several manners, including as examples molding, stereolithography, additive manufacturing, and digitally controlled machining. Examples include those described in Direct manufacture of orthodontic aligner appliance, US 20130122448, incorporated herein by reference.

The custom dental tray can be a direct match, with appropriate tolerances, for the patient's mouth, as is done with appliances for guarding against grinding. The custom tray can also be designed with new features that allow more patient benefits.

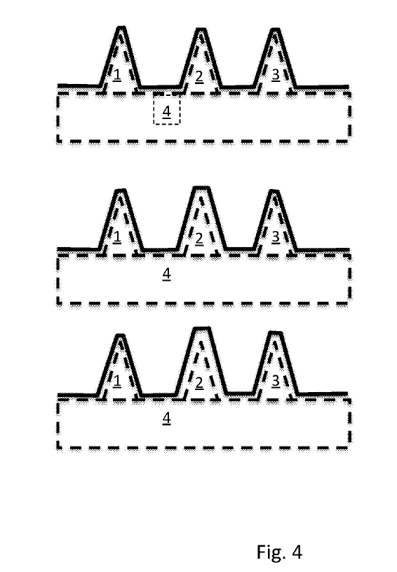

As one example application, the dental appliance can be designed so that there is excess space around portions of one or more teeth, as illustrated in FIG. 4. The dashed lines represent the gum and teeth of the patient, as in previous figures. The solid line represents the surface of the tray or appliance. In the top example in the figure, the tray allows approximately the same volume of therapeutic agent to be disposed adjacent each tooth. In the middle example in the figure, the tray allows for a greater volume of therapeutic agent to be disposed adjacent the middle tooth 2. In the bottom example in the figure, the tray allows for the volume of therapeutic agent to be designated for each tooth individually. Open volumes corresponding to some teeth may be tightly fitted to the teeth, or may have no therapeutic agent applied, if such teeth are not to be treated. Also, the composition of the therapeutic agent can be designated specific for each tooth, for example where one tooth might require an antiseptic specific to that tooth's condition. The excess space can be used to accommodate precise amounts of a therapeutic material, for example a tooth whitening compound, or a combination of glycerine (adds viscosity) xylitol (anti-cariogenic and anti-inflammatory) and NaCl (anti-infective). Other solutions, and variations of the example solution, can also be useful responsive to particular patient needs. This can help in treating or preventing dry mouth, which can lead to tooth damage and other patient problems. The amount of solution can be tailored for each tooth by calibrating the excess volume around the tooth in the custom appliance. The delivery location relative to each tooth can also be tailored by proper design of the shape of the recess allotted for each tooth.

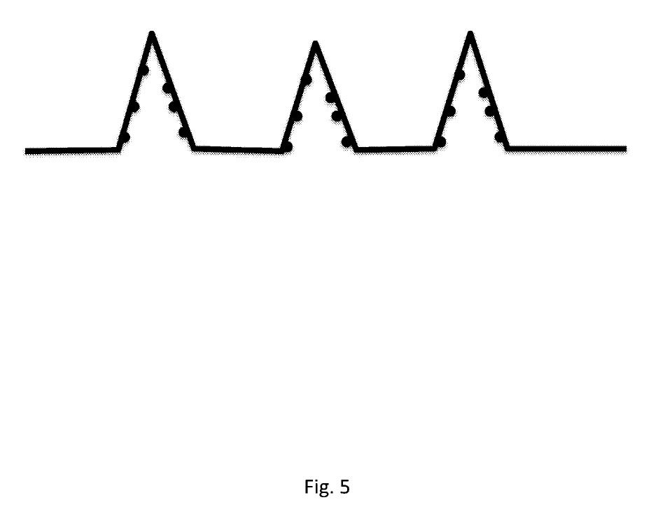

The internal surface of the appliance can also be designed and fabricated to accommodate or enhance retention and delivery of a therapeutic substance, as illustrated in FIG. 5. As examples, the porosity and permeability of the surface can be tailored to accommodate desired volume and flow rates of the therapeutic substance. Channels can also be provided in the surface, or penetrating the surface, to provide for transport of the therapeutic agent around a tooth or between teeth.

The combination of the several aspects of the design of the appliance can provide greater patient benefits than current single-purpose appliances. As an example, a patient already using an appliance for protecting against grinding can also receive therapeutic agents for tooth whitening or for protecting and nourishing all or individual teeth.

As another example embodiment, other portions of the appliance can be exploited to provide patient benefits. Olive oil spray to the back of the throat has long been a recommended therapy at bed time to reduce snoring. An appliance according to the present invention can be designed and produced, e.g., with an appropriately sized reservoir and appropriately sized opening therein, to release a small amount of lubricant through the night, which can coat the back of the throat and reduce airflow turbulence over dry membranes at the back of the throat, reducing snoring more effectively than a one-time application of lubricant such as olive oil.

The example embodiments containing and releasing therapeutic agents can be used in combination with a custom appliance as described herein. They can also be useful in “one size fits all” or “semicustom” (meaning, a variety of sizes intended to accommodate a range of mouth sizes and geometries) if a custom appliance is not practical, and if the corresponding loss of precision volume control around the teeth is acceptable.

Although the foregoing invention has been described in some detail by way of illustration and example for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference.

We claim:

1. A method of treating dry mouth condition in a patient, comprising:
(a) producing an appliance that is custom fit to the patient's teeth, with additional spaces configured to retain and deliver a therapeutic agent effective in treating dry mouth condition to teeth where treatment is desired;
(b) applying the agent to the appliance such that the therapeutic agent is retained in at least some of the additional spaces;
(c) mounting the appliance with the patient's teeth such that the appliance delivers the therapeutic agent to the teeth where treatment is desired.

2. A method as in claim 1, wherein producing an appliance comprises obtaining a digital representation of the patient's mouth, producing a three dimensional model of the patient's mouth from the digital representation, producing a three dimensional model of an appliance from the three dimensional model of the patient's mouth adjusted to provide space for a therapeutic agent to be disposed in the appliance and dispensed to the patient, and producing an appliance from the three dimensional model of the appliance.

3. A method as in claim 2, wherein the space for a therapeutic agent comprises open volumes adjacent one or more teeth, wherein each open volume is configured to accept a volume of therapeutic agent intended for the corresponding tooth.

4. A method as in claim 3, wherein at least some of the open volumes are configured to accept different volumes of therapeutic agent.

5. A method as in claim 1, wherein at least a portion of the surface of the appliance that will be disposed adjacent the patient's mouth has a porosity, permeability, or both configured to dispense a therapeutic agent at a desired release rate.

6. A method of producing an appliance suitable for applying a therapeutic agent to a patient's mouth, comprising obtaining a digital representation of the patient's mouth, producing a three dimensional model of the patient's mouth from the digital representation, producing a three dimensional model of an appliance from the three dimensional model of the patient's mouth adjusted to provide space for a therapeutic agent to be disposed in the appliance and dispensed to the patient, and producing an appliance from the three dimensional model of the appliance.

7. A method as in claim 6, wherein the space for a therapeutic agent comprises open volumes adjacent one or more teeth, wherein each open volume is configured to accept a volume of therapeutic agent intended for the corresponding tooth.

8. A method as in claim 7, wherein at least some of the open volumes are configured to accept different volumes of therapeutic agent.

9. A method as in claim 6, wherein at least a portion of the surface of the appliance that will be disposed adjacent the patient's mouth has a porosity, permeability, or both configured to dispense a therapeutic agent at a desired release rate.

10. An appliance, produced by the methods of claim 6.

11. A method as in claim 1, wherein the therapeutic agent comprises a combination of glycerine, xylitol, and NaCl.

12. A method as in claim 1, wherein the therapeutic agent comprises a viscosity controlling agent, an anti-cariogenic agent, an anti-inflammatory agent, and an antiseptic agent.
